(19) United States
(12) Patent Application Publication
(10) Pub. No.: US 2010/0223122 A1
(43) Pub. Date: Sep. 2, 2010

(54) SYSTEM, METHOD, AND STORAGE MEDIUM FOR PROVIDING VARIABLE CONSUMER-ORIENTED INFORMATION IN A RETAIL ENVIRONMENT

(75) Inventors: George Burling Prince, III, Marblehead, MA (US); Jeffrey Allen Martin, Marblehead, MA (US)

Correspondence Address: NIXON PEABODY LLP, 401 Ninth Street, N.W., Suite 900, WASHINGTON, DC, 20004, US

(73) Assignee: CBS Intractive, Inc., San Francisco, CA (US)

(21) Appl. No.: 12/715,149

(22) Filed: Mar. 1, 2010

Related U.S. Application Data
(63) Continuation of application No. 10/118,543, filed on Apr. 8, 2002, now abandoned.

(51) Int. Cl. G06Q 30/00; G06Q 10/00; G06F 17/30; G06F 17/00; G06F 3/048

(52) U.S. Cl. 705/14.41; 705/14.61; 705/14.65; 707/740; 700/94; 715/771; 707/E17.089

(57) ABSTRACT

An exemplary embodiment of the invention relates to a method, system, and storage medium for providing variable consumer information at a retail display location. The system comprises a host system further including a server; a commercial display services application including a user interface executing on the server; and a data storage device coupled to the server. The data storage device stores databases of diverse media formats including: a linked advertisement database operably configured to store audio-video advertising content and audio-video advertisement records; a static advertisement database operably configured to store static advertising content and static advertisement records; an audio clip database operably configured to store audio clip content and audio clip records; and a file database storing registration information; and a link to at least one retail entity. The host system provides advertisement programming services including customer registration; programming content selection selected from at least one of the linked advertisement database, the static advertisement database, and the audio clip database; programming content formatting; and assembly of the content resulting in an advertising program loop. The invention also comprises a method and storage medium.

### RELATED APPLICATIONS

This application is a continuation of U.S. patent application Ser. No. 10/118,543, filed Apr. 8, 2002, the contents of which are fully incorporated herein by reference.

### TECHNICAL FIELD

The present invention relates generally to computer-implemented commercial advertising and display services. More particularly, the present invention relates to a method, system, and storage medium for presenting variable consumer-oriented information in a retail environment.

### BACKGROUND ART

Commercial advertising is oftentimes perceived by television viewing audiences as intrusive and irritating, particularly during a favorite television program. Viewers are captive audiences of television advertisements unless they take active measures to avoid them, e.g., changing channels. The increased presence of VCRs and remote controls has led to the problems of zipping (i.e., fast forwarding through commercials during the playing of a previously recorded program), or zapping (i.e., the changing channels to avoid commercials). Others avoid commercials by using that time to tend to other activities. From a marketing point of view television advertising offers greater coverage capabilities than many other advertising mediums, however, those capabilities may be offset by its expensive and intrusive ‘push’-type nature. In other words, commercials are often presented at a time when the viewer is either not interested in receiving the information or does not otherwise desire the product or services being advertised. Unfortunately for a commercial sponsor, presenting a commercial to a viewer at inopportune moments, such as at the height of suspense in a television or sports program, can lead to frustration and perhaps even some resentment by the viewer.

Savvy manufacturers and marketing entities are continuously striving to keep viewers in their seats during commercial breaks by creating entertaining and novel commercials that sometimes rival even their programming counterparts with respect to maintaining the viewers' interest. Commercials utilizing well-known actors, musicians, and politicians are catching the attention of many of today's viewing audiences. High tech special effects, humor, and originality are becoming essential ‘tools of the trade’ for the advertising industry. For example, the makers of GAP™ jeans created a series of commercials targeted for young people that included high-energy, eye-catching dance routines performed by a groups of young people and set to popular music. Budweiser, Inc. has also enjoyed success with its series of animated frog commercials and “wazzup” commercials that prompted viewing audiences to talk about them for weeks.

Some of the most well known commercials have debuted during Superbowl Sunday football games, a highly televised national event. The practice of debuting high-quality commercials during Superbowl Sunday is fast becoming a tradition that is highly anticipated by viewing audiences. Further, notable ads that have debuted during these football games are often showcased during morning news shows in the days following the game and have arguably taken their place as a form of valuable entertainment in their own right. Today's commercials are given awards for their creative and entertainment value via an annual award event known as the Mobius Advertising Awards, developed by Mobius Awards, Ltd., an organization directed to recognizing exemplary print, radio, and television commercials.

Despite the advantages of creating new and innovative commercial content, television advertising is a nonselective medium. As such, it is difficult to reach a precisely defined market segment. This is likely due to changing variations in the composition of audiences due to variables such as program content, broadcast time, and geographic coverage. Buying airtime on a TV program does not guarantee a product's exposure but merely provides an opportunity to communicate a message to large numbers of consumers. Measuring the effectiveness of a television advertisement on the sale of a product can also be problematic for the product's marketing group.

More recently, other forms of advertising systems have surfaced in the marketing industry. For example, digital signage companies are beginning to pop up, taking advantage of the lowering costs of technology and widespread use of the Internet by the public in general. Digital signage messaging enables variable, point-of-use information, targeted for a selected audience. Also, interactive media such as Internet, online services, kiosks, and interactive TV are becoming increasingly utilized as advertising mediums and present some significant advantages over the traditional ‘passive’ channels. Interactive media allow the consumer to literally interact with the source of the information by offering targeted specific market segments, as well as direct dealings, with a user. Interactive media are providing new ways of getting messages out to the public.

Typical digital signage companies currently operating in the market today are primarily designed around a business model that targets captive audiences (e.g., visitors waiting in line, in an elevator, in a waiting room, on an exercise bike, etc.). For example, Netpulse™ provides digital messaging services to health clubs via displays such as those found on a treadmill. Information provided may include health and dieting tips, as well as information targeted to the type of individuals likely to be using that treadmill. The value proposition to the viewer is not so much to be informative as it is to entertain, i.e. to make the wait more tolerable.

In exchange for a more tolerable wait, the viewer ‘agrees’ to watch advertising. Thus, the business model utilized is referred to as a ‘push’ advertising model—an audience that, even if they are receptive to the advertising, cannot act on the message (since they are preparing to leave the store, are stuck in an elevator, waiting for a doctor, etc.).

In-store advertising has been a mainstay for retailers and businesses for many years. In the past, in-store advertising methods were limited to static display ads with large bold printed pricing and product information. With advances in technology, various forms of magnetic media and digitized advertising systems have yielded in-store access to commercial information via terminal devices displaying one or more advertisements relating to product items that are located in a particular area of the store and which continuously repeat throughout the day coinciding with the store's hours of operation. In-store commercial display systems typically transmit a fixed number or series of advertisements collected and presented in a looping arrangement to provide continuous and repetitive advertisement displays via video/audio cassette, compact disk, static images and text, etc.

While some of the store's browsing customers may be exposed to an advertisement that is repeated once or twice during the course of a store visit, the same cannot usually be said for the store's employees. Depending upon the duration of the advertising loop, store employees may be subject to repeating commercials for many hours, and perhaps, even days or weeks. While busy employees may be free to avert their eyes from these ads, they nonetheless cannot escape the repetitious exposure to the audio portion while within hearing distance. Some employees may be tempted to turn down the sound, which may not be in the best interests of the marketers whose products are being advertised. A secondary disadvantage of this type of advertising is the ripple effect caused by the overexposure of employees to these advertising loops throughout a working day. Not only can this result in a less than ideal work environment and diminished productivity, but this repeated exposure can cause an employee to become agitated and impatient which may then have a negative effect on the store's customers, resulting in an unpleasant shopping experience.

Another disadvantage involves a situation in which customers who regularly frequent the store are subjected to the same commercial advertising loops. Studies have shown that individuals who have been repeatedly exposed to the same stimulus, whether it is audio, video, or any matter affecting the senses, may eventually become habituated to the stimulus, developing an unconscious ability to tune it out or at least a substantial portion of it. This, again, is not very good news for marketers who rely on this type of advertising method.

What is needed is a commercial display system that provides variable, interesting, and useful information and audio content to viewers at a location where the customer needs it, and that is designed to pull in a viewing audience and provide customizable capabilities.

### SUMMARY OF THE INVENTION

An exemplary embodiment of the invention relates to a method, system, and storage medium for providing variable consumer information at a retail display location. The system comprises a host system further including a server; a commercial display services application including a user interface executing on the server; and a data storage device coupled to the server. The data storage device stores databases of diverse media formats including: a linked advertisement database operably configured to store audio-video advertising content and audio-video advertisement records; a static advertisement database operably configured to store static advertising content and static advertisement records; an audio clip database operably configured to store audio clip content and audio clip records; and a file database storing registration information; and a link to at least one retail entity. The host system provides advertisement programming services including customer registration; programming content selection selected from at least one of the linked advertisement database, the static advertisement database, and the audio clip database; programming content formatting; and assembly of the content resulting in an advertising program loop. The invention also comprises a method and storage medium.

### BRIEF DESCRIPTION OF THE DRAWINGS

Referring now to the drawings wherein like elements are numbered alike in the several FIGURES:

FIG. 1 is a block diagram of a portion of a computer network system on which the commercial display services tool is implemented in an exemplary embodiment of the invention;

FIG. 2 is an exemplary static advertisement database illustrating a sample static advertisement record utilized by the commercial display services tool;

FIG. 3 is an exemplary commercial advertisement database illustrating a sample audio/video-linked commercial advertisement record utilized by the commercial display services tool;

FIG. 4 is an exemplary audio clip database illustrating a sample audio clip record utilized by the commercial display services tool;

FIGS. 5A and 5B represent a flowchart describing the process for establishing and implementing a customized, variable commercial display program via the commercial display services tool for subsequent display at a user location in an exemplary embodiment;

FIG. 6 is a sample time line graph illustrating the implementation of the scheduling features of the commercial display services tool in an exemplary embodiment; and

FIG. 7 is a sample commercial display services tool user interface screen for implementing the commercial display services tool in accordance with an exemplary embodiment of the invention.

### DETAILED DESCRIPTION OF THE INVENTION

The commercial display services tool enables variable commercial programming for display at a retail location. The programming content is selected by a user and may include linked audio/video commercials as well as unlinked (e.g., static advertisements) that are linked with variable audio data that is formatted to fit a time schedule and data format determined by a user. The commercial program generated by the tool may be configured to ensure that no audio portion or limited audio is repeated during a programming loop. The unlinked audio data comprises vast amounts of various vocal and/or instrumental items, including trivia, news, local content, music, etc. provided by the commercial display services tool.

The commercial display services provided by the commercial provider system and the commercial display services tool may be used alone or in combination with supplementary advertisement and messaging tools that provide extensive customized graphics services, advertisement scheduling for display systems, and local and national content for display. Local and national content can be collected for simultaneous display on multi-tiled display screens. Such advertising techniques may be particularly useful in ‘pulling’ viewers to display areas rather than display areas ‘pushing’ continuous advertisements at the viewers. Examples of local content providers include Reuters™, MediaCast™, Dfilm.com™, and Newstream.com™ Advertisements may be scheduled for display on multi-tiled display screens during designated time slots. Tiles include large and small rectangular shaped windows as well as elongated strips of text-formatted windows for displaying ‘looping’ text or data materials. Images and graphics can be still frames or fixed images, or may be moving multi-media graphics and text with audio accompaniment. These advertisement tools may be proprietary in nature, or may utilize the digital messaging tool described in U.S. patent application Ser. No. 09/836,890 entitled, “Method and System for Providing Digital Messaging Services”, filed on Apr. 17, 2001 and which is incorporated herein by reference in its entirety.

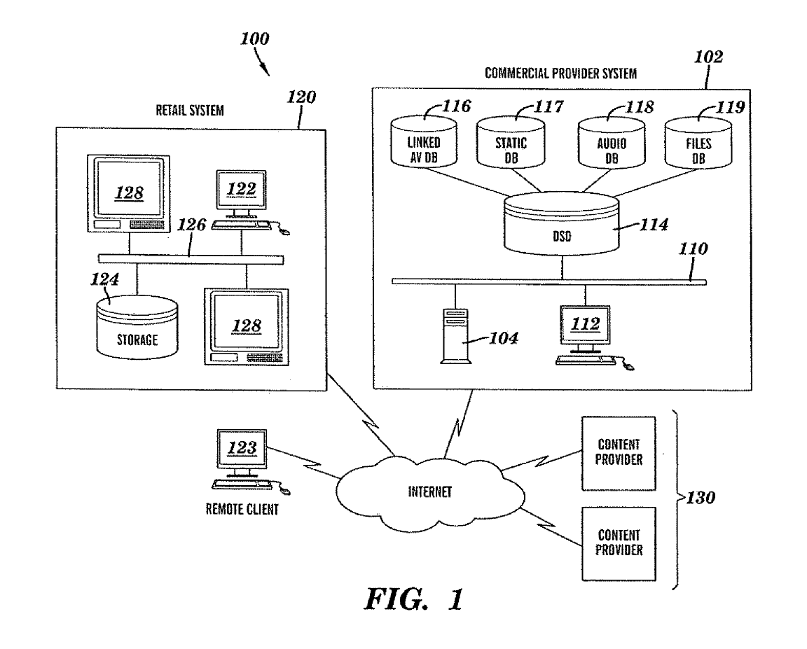

A portion of an exemplary network system 100 on which the invention might be used is shown in FIG. 1. System 100 comprises a commercial provider system 102 (also referred to as host system) for implementing the commercial display services tool of the invention. Host system 102 may be connected to the Internet via plain old telephone service (POTS), DSL, T-1, ISDN, or other high-speed communications medium known in the art. In a preferred embodiment, host system 102 provides commercial programming services via the Internet to commercial display systems such as retail system 120 utilizing the commercial display services tool and supporting system devices. Host system 102 may provide the necessary hardware, software, network connections, information services, and system maintenance and repair to subscribing customers such as retail system 120 for a monthly fee.

Although not necessary to realize the advantages of the present invention, host system 102 may be part of a wide area network (WAN), virtual private network (VPN), or a combination of both in which different geographical locations are interconnected, either by high-speed data lines or by radio links, interconnecting multiple workstations at widely disparate locations. In the simplified diagram of FIG. 1, host system 102 includes a server 104 that is in communication with data storage device 114 and workstation 112, via network connection 110 and with entities outside of host system 102 via an internetwork system such as the Internet. For purposes of illustration, network 110 is an intranet network infrastructure operating on a local area network (LAN). Network 110 connects server 104 to the Internet. Server 104 includes web server software for hosting and serving web pages of host system 102. Server 104 also includes applications software including the commercial display services tool of the invention for initiating customer registration, authorizing access to host system's 102 applications, directing visitor requests, and for facilitating the transmission of assembled advertisement programs and/or unassembled content to a viewing system such as retail system 120 as described further herein. The term ‘advertisement program’ is used herein to describe the information presented for display on display screens 128 and includes digital video file formats such as AVI, MPEG, Flash (SWF), OMF, DVCam, Real Media, MOV, static images and text.

Workstation 112 communicates with server 104 and data storage device 114 via network 110. Workstation 112 may be a general-purpose computer, or personal computer (PC) and includes a keyboard or other input device for entering commands and accessing applications and data associated with entities of host system 102 such as server 104 and data storage device 114. System maintenance personnel and administrative personnel may be typical users of workstations 112. Alternatively, server 104 may include a monitor, input device and storage medium in lieu of workstation 112 and data storage device 114.

In a preferred embodiment, data storage device 114 houses advertising content in which linked audio/video advertisements, static advertisements, and audio clips are stored as well as customer and supplier registration information as described further herein. Alternatively, some of the advertising content may be stored at the content provider sites 130 as will be described further herein.

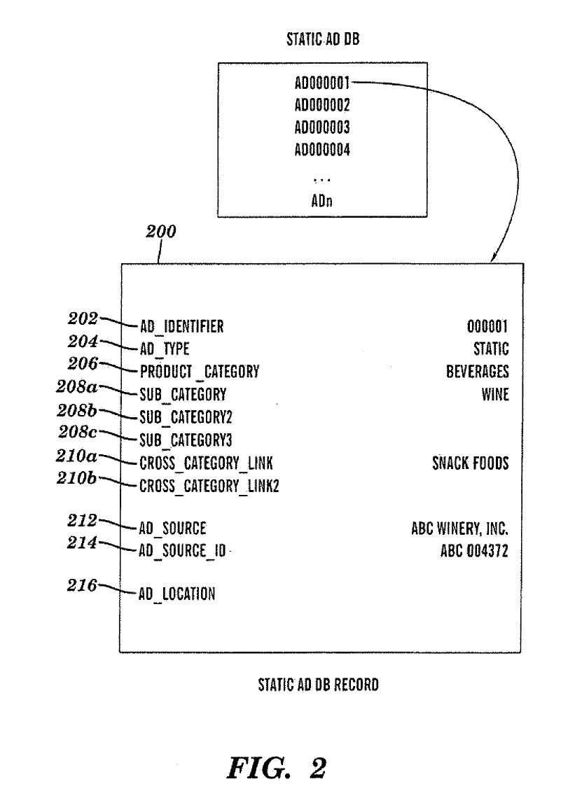

Static ad database 117 warehouses ‘still form’ advertisements such as digital photographs or graphics images and text. Static ads refer to those that are not accompanied by audio. These may also be obtained from product manufacturers, service providers, local businesses, etc. Static ad database 117 also stores static ad records as shown and described in FIG. 2.

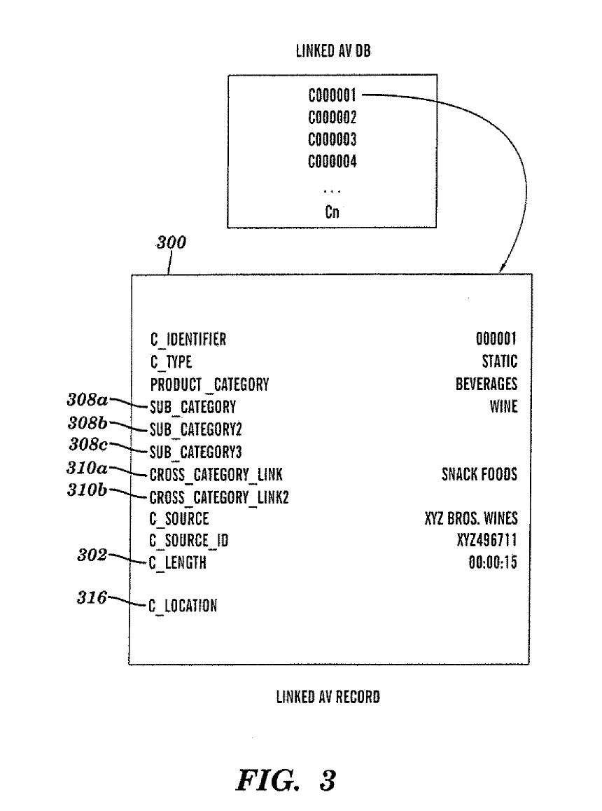

Linked audio/video database 116 (also referred to as “linked AV database”) houses audio/video advertisements obtained from product manufacturers or service providers pursuant to an agreement. Typical examples of linked AV ads include those presented on television. These advertisements are digitized for storage in database 116 and may be stored on a system hard drive, compact disk or CD-ROM for subsequent retrieval. Linked AV database 116 also stores individual linked AV records as shown and described in FIG. 3.

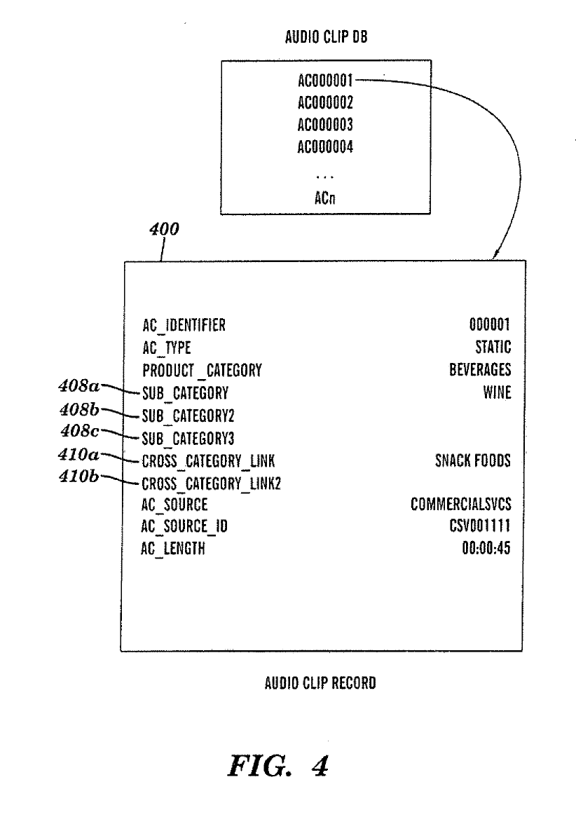

Audio database 118 stores digitized audio data that is used to accompany static ad displays as will be described further herein. Digitized audio data may include trivia and short segments of vocal or instrumental data of interest to consumers. The audio data preferably comprises a variety of human voices for ensuring diverse content and alternative presentations. Audio database 118 also stores individual audio clip records as shown and described in FIG. 4.

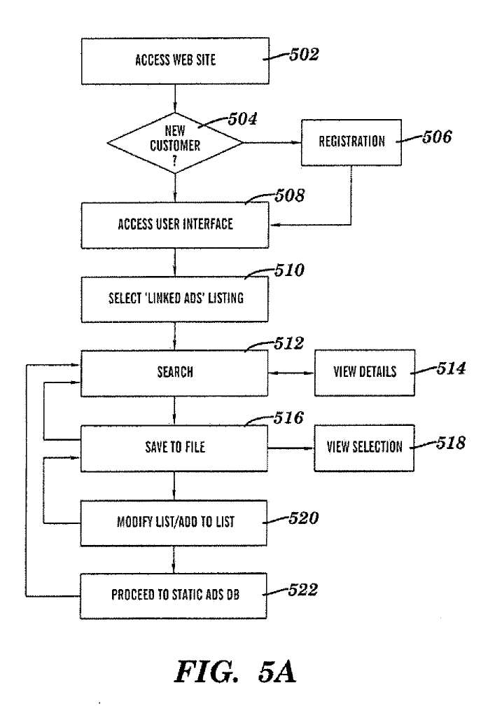

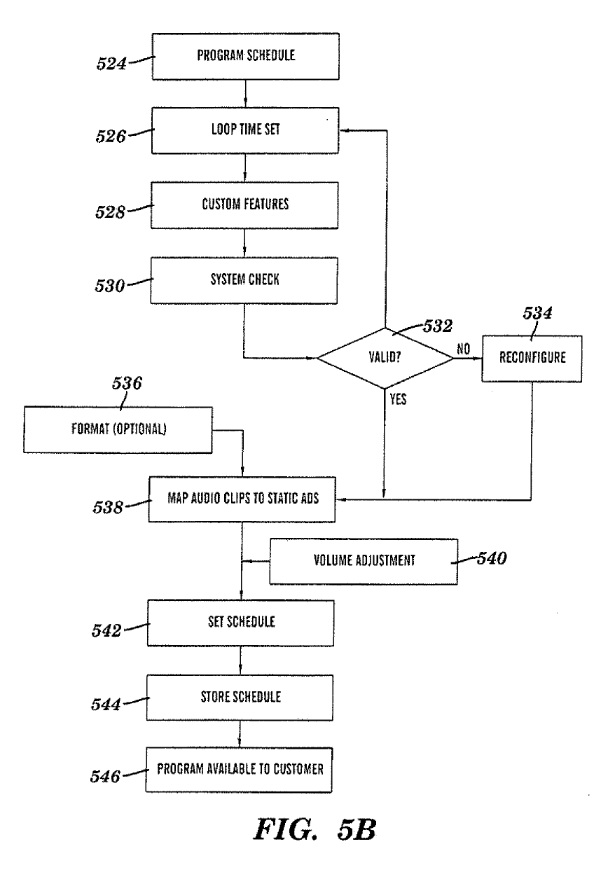

In a preferred embodiment, data storage device 114 stores the ad content and allows access to retail system 120 for retrieving selected ads used in generating a program loop. Retail system 120 downloads preferred ads and assembles the content via scheduling software provided by host system 102. In this manner, the resulting program loop would be stored at retail system 120. In an alternative embodiment, customer files database 119 (also referred to as “files database”) stores assembled advertisement programs (also referred to as program loops) created by or on behalf of users. In this embodiment, retail systems such as retail system 120 call out at scheduled times to download appropriate files from database 119, although other means of transmission may be employed. These ad programs include single images and loops of material or advertisement content that have been processed by the commercial display services tool as described further in FIGS. 5A-5B.

In a further embodiment, data storage device 114 stores the records associated with the content described above with respect to static ad database 117 and linked AV database 116 but not the actual ad content. Content may be stored at the content providers 130 sites and accessed by authorized subscribers of the commercial provider system in accordance with content selection and/or commercial provider system 102 alone. In this embodiment, records associated with the selected content contain information pointing to the location of the content in storage (see generally AD_LOCATION field 216 of FIG. 2 and C_LOCATION field 316 of FIG. 3). In yet another embodiment, storage of content may be shared by commercial provider system 102 and content providers 130 if desired.

Also included in system 100 is retail system 120 comprising a computer device 122 coupled to a data storage device 124 and display screens 128 via a communications link 126. Retail system 120 may be a department store, grocery store, pharmacy, or other similar establishment that subscribes to or receives host system's 102 services. For purposes of illustration, retail system 120 is a liquor store. Computer device 122 may be a general-purpose computer and includes an internal or external memory such as data storage device 124, and a modem capable of communicating with host system 102. In a preferred embodiment, retail system 120 is provided with access to host system's 102 content databases. The commercial display services tool can be configured to allow a user to select an automated dial up feature that causes computer device 122 to periodically dial up host system 102 via the Internet and receive content for presentation on display 128. Computer device 122 may also include an input device such as a keyboard and web browser software capable of accessing host system's 102 web site and registering for commercial display services. The services may also be accessed remotely via remote client 123. Remote client 123 represents a personal computer (PC) or general-purpose computer and includes an input device such as a keyboard, mouse, etc. Alternatively, a similar web-enabled device may be utilized in lieu of remote client 123 such as a laptop, PDA, or other suitable appliance. In a preferred embodiment, data storage device 124 stores selected ad programs generated via the commercial display services tool, as well as any proprietary information desired by retail system 120. As described above, retail system 120 can dial out at scheduled intervals to the Internet to collect whatever content is desired. This action can be automatic at designated time intervals, and programmed earlier by data obtained from host system 102. Alternatively, ad programs may be housed in files database 119 at commercial provider system 102 for subsequent query and retrieval by retail system 120. Each of display screens 128 may be a monitor, kiosk, screen or other vehicle that displays images and text and may be a cathode ray tube (CRT), liquid crystal display (LCD), gas plasma, or other similar type display. Display screens 128 may be equipped with product scanning devices whereupon scanning an item causes computer device 122 and data storage device 124 to provide an image, sound, or a combination of the two. Input devices other than scanners may be used to initiate this effect as well. In one embodiment, display screens 128 include microphones (not shown) for allowing commercial provider system 102 to monitor volume levels of advertising programs running at retail location 120. Volume monitoring is described further in FIG. 5. Display screens 128 include speakers (not shown) for presenting audio. Alternatively, display screens 128 may each be in communication with system devices of retail system 120 in a wireless fashion. Additionally, any number of display screens may be simultaneously utilized by retail system 120, each capable of displaying different content. The term ‘content’ refers to formats of information display and includes any type of format known in the art including voice, video, and text materials.

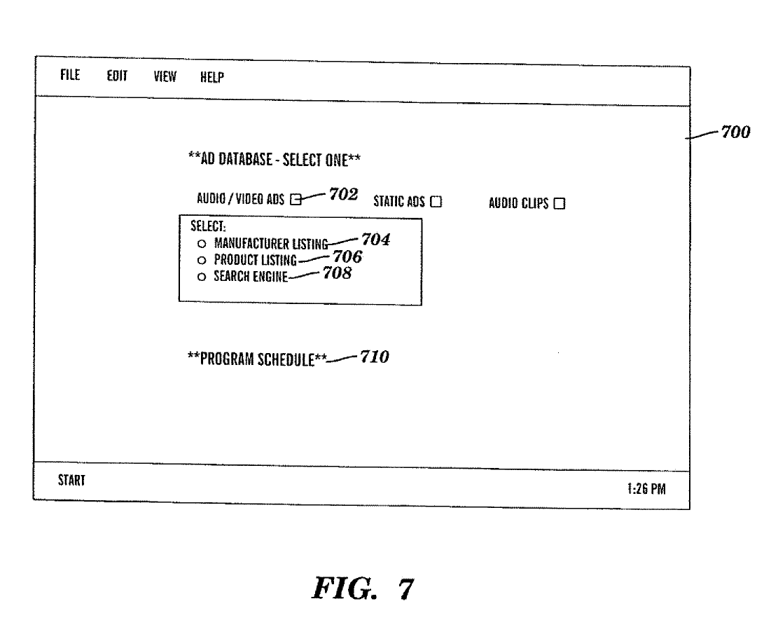

A user may access the services of the commercial display services tool via the Internet on any commercially available PC. This can be done either at the retail site where computer device 122 is equipped with an input device and web browser or may be accomplished remotely by an authorized user at a computer such as remote client 123. A user interested in receiving the services of the commercial display services tool may access a user interface provided by the tool. A sample user interface for accessing the features and functions of the commercial display services tool is shown in FIG. 7. The user interface of the commercial collection and display services tool may also be configured to allow retail system 120 to browse through and select commercials, receive assistance in locating a particular commercial, provide maintenance and receive assistance in the operation of the tool, etc. The input devices provide access to the user interface. Once the content has been selected, the user may utilize the scheduling services of the tool either online or via software provided by host system 102. This is described further herein.

FIG. 2 illustrates a sample static advertisement record format. Static ad record 200 includes various fields of data for facilitating the storage and retrieval of static ads in database 117. AD_IDENTIFIER field 202 refers to a numeric or alphanumeric identifier assigned to a particular record. Identifiers may be assigned to records in a sequential fashion or may be selected utilizing a random number generator or similar tool. AD_TYPE field 204 identifies the ad as a static advertisement for differentiating between the various content stored in data storage device 114. PRODUCT_CATEGORY field 206 allows for the cataloging of advertisements into various classifications for quick retrieval as well as for associational purposes as will be described further herein. SUB_CATEGORY, SUB_CATEGORY2, and SUB_CATEGORY3 fields 208 further define and classify advertisements in a hierarchical fashion such as from general to specific products. CROSS_CATEGORY_LINK field 210 provides a link to related products and categories for allowing a user of the commercial display services tool to find and schedule complementary advertisements as desired. For example, an advertisement for a SUB_CATEGORY of wine may be compatibly scheduled and displayed at a retail display screen 128 in close proximity to a CROSS_CATEGORY_LINK “Snack Foods”. Thus, for example, a user of the commercial display services tool may be able to schedule a wine commercial back-to-back with a snack food commercial, or alternatively, may simultaneously display the wine commercial and snack food commercial on separate display screens in close proximity to one another in a retail store.

AD_SOURCE field 212 identifies the product supplier related to the record and can be used by commercial display services tool to cross-reference files database 119 for obtaining further information about the supplier. AD_SOURCE_ID field 214 further identifies the supplier related to the record and refers to an assigned identifier unique to the supplier. AD_LOCATION field 216 points to the location of the content in storage. As described above, the content may be stored locally in data storage device 114 or at the respective content provider system 130.

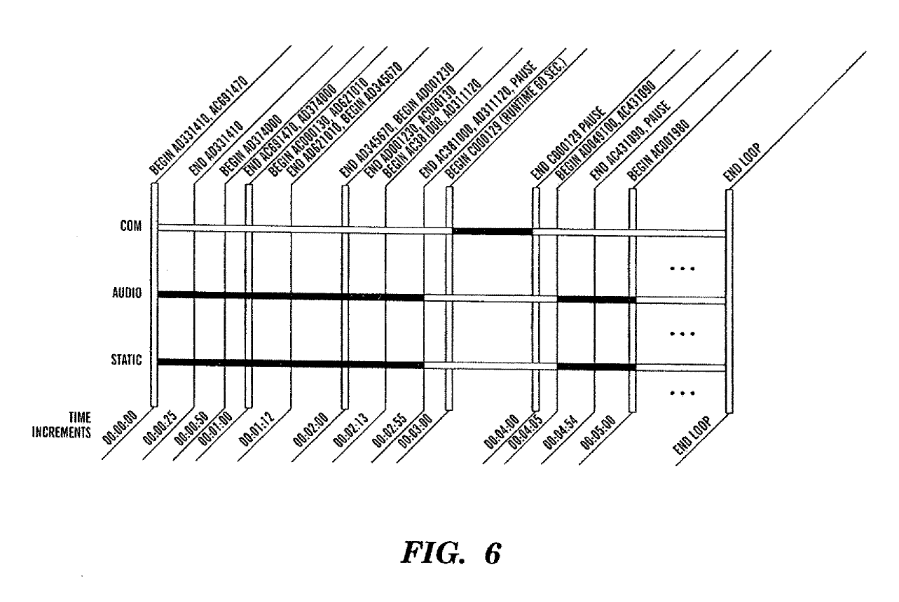

FIG. 3 illustrates a sample linked AV database and sample record related to advertisements stored in linked AV database 116. The fields described in linked ad record 300 are similar to those described above in FIG. 2 and will not be discussed in detail with the exception of C_LENGTH field 302. C_LENGTH field 302 identifies the “runtime” associated with the linked ad associated with record 300. This field 302 may be used by the commercial display services tool to plan and schedule ad programming in accordance with a customer's programming requests (discussed in FIGS. 5A-5B), as well as to accommodate the display of advertisements selected from static ad database 117 and audio database 118. A portion of a sample schedule is illustrated in FIG. 6.

Audio clip records, a sample 400 of which is illustrated in FIG. 4, function similarly to those described in FIGS. 2 and 3 and will not be discussed further herein.

Commercial provider system 102 obtains commercial advertisements and/or data for content records from various product manufacturers (also referred to as suppliers) and stores them in one of databases 116 and 117. A user (also referred to as customer) at a retail system can register for and implement the features and functions of the commercial display services tool as described further herein.

FIG. 5A illustrates the process of selecting advertisements stored in databases 116, 117, and 118 for implementation at retail system 120. A user at retail system 120 or remote client 123 accesses a web site for host system 102 at step 502. The system queries the user whether he is a new or existing customer at step 504. If new, the user is guided through a registration process at step 506, providing general information such as business name, contact information, type of business, log-in password data, etc. Once the registration is complete, or alternatively if the user is an existing customer, the tool presents him with a user interface screen at step 508, a sample of which is shown in FIG. 7 for illustrative purposes.

The functions of the commercial display services tool include selecting from an assortment of audio/video (also referred to as ‘linked’) ads from database 116 and static (also referred to as ‘unlinked’) ads from database 117 which are then used to compile a customized advertisement program or loop. The tool automatically provides variable audio clips to the unlinked static ads, formats the data if necessary, and generates a program schedule as described further herein. The user selects the ‘audio/video’ function 702 from the menu screen 700 provided at step 510. The commercial display services tool provides the user with one or more search options such as an alphabetical listing of manufacturers or suppliers 704, an alphabetical listing of commercial products 706, and a search engine 708, etc. Upon entering the search criteria, the tool performs a search of linked AV database 116, retrieves the item(s) found, and displays a listing of the found item(s) for the user at step 512. The user may obtain further details about the item(s) found by selecting ‘view details’ at step 514. For example, the search term, ‘Budweiser’, may result in a list of all current commercials originating from Budweiser, Inc. The list presented may include short titles of the ads along with a brief description. The user may then highlight the desired record and select ‘view details’. The tool retrieves and presents a detailed description of the ad and/or may provide the user with a short clip of the ad.

The user has the option to either continue to view additional items on the list, or may save the desired item to a file that is associated with the user at step 516. Once completed, the user can view the selection of items in the file at step 518. The user may also modify the list at any time as desired at step 520. Once all ads have been selected, the user then proceeds to search static ad database 117 for more advertisements at step 522. The advertisement selection process for the static advertisements is similar to that described in FIG. 5A with respect to the combined audio/video advertisements and so will not be described further. The user may also select audio clips used to accompany the static ads selected. Audio clips are stored in database 118 and may be played according to clip types (e.g., trivia, local news, etc.). Further, each clip type may be further categorized by subject matter. For example, a user at retail system 120 who sells wine may wish to select trivia topics related to wine history, favorite wines of celebrities, planning a dinner party with wine, etc. This process of selecting audio clips may be accomplished in a manner similar to the ‘linked ads’ selection process described above in steps 512-520 and will not be discussed further herein.

Once the ads have been selected, the user may download the ads to data storage device 124 and perform scheduling activities utilizing software provided by host system 102. Alternatively, host system 102 may automatically compile all the ads for delivery to computer device 122 and display 128. The user may let the system run itself, or may choose the order of the content and would be directed to perform scheduling functions via the tool. The user selects ‘program schedule’ from menu screen 700 presented at step 524. The tool queries the user to select a loop time set from a drop down menu at step 526 and list in order the content ads. The system would automatically view the order and calculate the time needed to synchronize the audio selection with the unlinked or static ads and then calculate the total linked and static loop ‘run time’ accordingly.

The commercial display services tool processes the selected advertisements (from FIG. 5A) along with the scheduling data provided in step 526. Optional custom features may be provided at step 528, allowing a user more control over the program loop selection. For example, customized features may include designating a specific time during the loop where a specified ad will play. This may be useful where a retailer expects varying numbers and types of visitors throughout the store's hours of operation. For example, a grocery store may want to target its young customers with candy, soda, bubblegum or ice cream during ‘after school’ hours of a week day. A liquor store may want to display an ad for a product it is promoting during the weekend when business is typically busy. Other customized features include the ability to schedule preferred ads ‘back-to-back’ for optimum effect. Another scheduling feature allows the scheduling individual to program linked ads for a specific product to be displayed during a first program loop and then program a static ad to be displayed for the same product during a second program loop. These loops can be alternated a number of times for any desired products that have content available for both linked and static ads. The subcategory fields 208, 308, and 408, as well as the cross-category link fields 210, 310 and 410 of the records of FIGS. 2-4 facilitate these and other custom programming capabilities. For example, a user may select and compile a series of sound clips relating to a single static ad, resulting in a ‘sub sound loop.’ One or more sub sound loops could be programmed to run continuously or at specified intervals. These scheduling and custom features are collected at step 530 and compared at step 532. This is to ensure that the aggregated run times of the items selected by the user comport with the loop time or program schedule time selected. If invalid, the system reconfigures the reservoir of audio clips and continues with process at step 534. If the selected items are determined to be valid, it may be necessary to format the data so that it is compatible with the system requirements of the retail system at step 536. Retail system 120 may employ the necessary hardware and software for formatting or converting the advertisements according to these requirements. All programs generated by the tool are preferably stored in a respective client system database such as retail system data storage device 124. The tool maps audio content to the selected static ads according to compatibility criteria and time criteria at step 538. At step 540, a volume regulator device may be utilized by the commercial display services tool to compare the record volume levels of each selected linked ad and audio clip and regulate or level any disparities in order to achieve an ‘even quality’ as presented to display system 128. Alternatively, sound level adjustment may occur at the time the linked ads are received by commercial provider system 102 from suppliers. The volume regulator may be configured to monitor volume levels at a location via microphones provided within or nearby display devices 128. A volume level may be established and implemented via server 104 in which adjustments are made to volume levels of advertising programs currently running on one or more display screens 128 where the volume monitor detects a disparity in the volume level noted via the microphone and the volume level set via server 104. Any suitable volume regulator device known in the art may be utilized by the commercial display services tool in order to achieve the advantages of the invention. Once completed, the advertisement schedule is validated at step 542 and stored in file database 119 or data storage device 124 at step 544. A portion of a sample ad program schedule is shown in FIG. 6 herein and depicts five minutes of a program loop. The user may receive these schedules either by electronic download capabilities or may receive them via any distribution channels desired at step 546. Preferably, the ad program is stored locally in data storage device 124. The desired commercial program is ready for viewing by customers, visitors, and employees of retail system 120. It should be noted that the steps provided in FIGS. 5A-5B may be performed out of the order presented and that the steps as shown are provided for illustrative purposes only.

Commercial program schedules may be periodically reviewed and modified by retailer system 120 in order to evaluate the continued desirability/currency of existing advertisements. Upon such evaluation or upon a request, files made be added and deleted from the program. The web site at host system 102 may provide details relating to updates in the content available for selection. Registered users may be billed by host system 102 according to the services selected and by utilizing their registration information.

Information maintained in customer records of file database 119 may be processed in a manner such that useful reports, audits, measurements, and accounting information can be obtained. Some of this information may be made available to retail system 120 for assessing the effectiveness of the advertisements displayed. For example, the retailer obtains reports on what products were advertised during a block of time and compares that information with the sales receipts for that same time frame. The retailer is now equipped to compare and contrast pre- and post-advertising sales activities over time in order to obtain useful marketing information. This information also enables the retailer to better understand which types of content customers prefer, facilitating quick and inexpensive alterations in the nature and types of content to be scheduled in the future.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring to cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not by limitation.

What is claimed is:

1. A system for providing variable consumer information at a retail display location, comprising:
a host system, including:
a server;
a commercial display services application including a user interface, said commercial display services application executing on said server; and
a data storage device coupled to said server, said data storage device storing databases of diverse media formats including:
a linked advertisement database operably configured to store audio-video advertising content and audio-video advertisement records;
a static advertisement database operably configured to store static advertising content and static advertisement records;
an audio clip database operably configured to store audio clip content and audio clip records; and
a file database storing registration information; and
a communications link to at least one retail entity;
wherein said host system further includes an advertisement programming application operably configured to initiate customer registration; to enable a remote user to send a request from the at least one retail entity to said host system to select a plurality of content from at least one of said linked advertisement database, said static advertisement database, or said audio clip database; to enable the remote user to specify programming content formatting; and to assemble the selected content into a user-customized advertising program loop for presentation at the at least one retail entity.

2. The system of claim 1, wherein said audio-video advertisement records, said static advertisement records, and said audio clip records include data fields operable for:
identifying and retrieving records in storage;
identifying entities supplying records;
categorizing records; and
cross-referencing records according to pre-defined criteria.

3. The system of claim 2, wherein said linked advertisement database and said audio clip database each comprises a runtime data field specifying an execution time related to said audio-video advertising content and said audio clip content, respectively.

4. The system of claim 1, wherein said host system further includes a volume regulator device operable for normalizing volume levels of selected advertising content provided in said advertising program loop.

5. The system of claim 1, wherein said advertisement programming application includes a scheduling function wherein a unique identifier associated with said audio-video advertisement records, said static advertisement records, and said audio clip records is used for determining placement of an ad in said advertising program loop.

6. The system of claim 1, wherein said user interface assists users in defining parameters of said advertising program loop.

7. The system of claim 6, wherein said parameters include a field operable for specifying a specific time slot in said advertising program loop for presenting a selected advertising content.

8. A commercial display services tool including a user interface for generating an advertising program loop, comprising:
a linked advertisement record;
a static advertisement record;
an audio clip record;
wherein said linked advertisement record, said static advertisement record, and said audio clip record include data fields operable for identifying a location of advertising content in a database, identifying a provider of said advertising content, categorizing said advertising content, and cross-categorizing said advertising content for allowing a remote user at a retail location to access said user interface over a communications network to select and schedule a plurality of advertising content for assembling a user-customized advertising program loop for presentation at the retail location.

9. A method for providing variable consumer-oriented information at a retail display location via a commercial display services tool, comprising:
receiving a request to generate a user-customized advertising program loop from a remote user at a computer workstation associated with said retail location;
initiating execution of said commercial display services tool by a hosting system;
providing a user interface screen to said workstation;
providing access to at least one database of diversely formatted advertising content via said user interface screen;
receiving user input from the remote user to select a plurality of content for assembling said user-customized advertising program loop for presentation at said retail location;
retrieving records for the selected content;
receiving responses to requests for scheduling criteria;
comparing data in said records to said responses to requests for scheduling criteria; and
based upon said comparing, assembling the selected content according to said scheduling criteria into said user-customized advertising program loop, wherein said advertising program loop is transmitted to a storage location.

10. The method of claim 9, wherein said diversely formatted advertising content includes:
audio-video advertisements;
static advertisements; and
audio clips.

11. The method of claim 9, wherein said scheduling criteria includes:
a loop time;
customized presentation functions including:
back-to-back display instructions;
no back-to-back display instructions;
sub sound loop generation capabilities;
repeat display instruction; and
match audio clip to static advertisement instructions; and
a volume regulator device.

12. The method of claim 9, wherein said comparing data in said records to said responses to requests for scheduling criteria includes:
determining runtimes of selected content;
aggregating runtimes of selected content;
determining loop time selected;
evaluating customized placement instructions; and
assessing validity of said responses.

13. A storage medium encoded with machine-readable computer program code functions that provide variable consumer-oriented information at a retail display location via a commercial display services tool executing on a computer, the storage medium comprising:
a first computer program code function that causes said computer to receive a request to generate a user-customized advertising program loop from a remote user at a computer workstation associated with said retail location;
a second computer program code function that causes said computer to initiate execution of said commercial display services tool by a hosting system;
a third computer program code function that causes said computer to provide a user interface screen to said workstation;
a fourth computer program code function that causes said computer to provide access to at least one database of diversely formatted advertising content via said user interface screen;
a fifth computer program code function that causes said computer to receive user input from the remote user to select a plurality of content for assembling said user-customized advertising program loop for presentation at said retail location;
a sixth computer program code function that causes said computer to retrieve records for the selected content;
a seventh computer program code function that causes said computer to receive responses to requests for scheduling criteria;
an eight computer program code function that causes said computer to compare data in said records to said responses to requests for scheduling criteria; and
a ninth computer program code function that causes said computer to assemble the selected content, based upon an output of said eight computer program code function and according to said scheduling criteria, into said user-customized advertising program loop that is transmitted to a storage location.

14. The storage medium of claim 13, wherein said diversely formatted advertising content includes:
audio-video advertisements;
static advertisements; and
audio clips.

15. The storage medium of claim 13, wherein said scheduling criteria includes:
a loop time;
customized presentation functions including:
back-to-back display instructions;
no back-to-back display instructions;
sub sound loop generation capabilities;
repeat display instruction; and
match audio clip to static advertisement instructions; and
a volume regulator device.

16. The storage medium of claim 13, wherein said eight computer program code function includes:
computer program code function that causes said computer to determine runtimes of selected content;
computer program code function that causes said computer to aggregate runtimes of selected content;
computer program code function that causes said computer to determine loop time selected;
computer program code function that causes said computer to evaluate customized placement instructions; and
computer program code function that causes said computer to assess validity of said responses.

17. A system for providing variable consumer information at a retail display location, comprising:
a host system, including:
a server;
a commercial display services application including a user interface, said commercial display services application executing on said server; and
a data storage device coupled to said server, said data storage device storing at least one database of advertising content and advertising records; and
a communications link to at least one retail entity;
wherein said host system further includes an advertisement programming application operably configured to initiate customer registration; to enable a remote user to send a request from the at least one retail entity to said host system to select a plurality of content from said at least one of said advertisement database; to enable the remote user to specify programming content formatting; and to assemble the selected content into a user-customized advertising program loop for presentation at the at least one retail entity.

18. The system of claim 17, wherein said advertising records includes data fields operable for:
identifying and retrieving records in storage;
identifying entities supplying records;
categorizing records; and
cross-referencing records according to pre-defined criteria.

19. The system of claim 18, wherein said advertisement database comprises a runtime data field specifying an execution time related to audio-video advertising content.

20. The system of claim 17, wherein said host system further includes a volume regulator device operable for normalizing volume levels of selected advertising content provided in said advertising program loop.

21. The system of claim 17, wherein said advertisement programming application includes a scheduling function wherein a unique identifier associated with audio-video advertisement records, static advertisement records, and audio clip records is used for determining placement of an ad in said advertising program loop.

22. The system of claim 17, wherein said user interface assists users in defining parameters of said advertising program loop.

23. The system of claim 22, wherein said parameters include a field operable for specifying a specific time slot in said advertising program loop for presenting a selected advertising content.
